(19) United States
(12) Patent Application Publication
(10) Pub. No.: US 2014/0357364 A1
(43) Pub. Date: Dec. 4, 2014

(54) FLEXIBLE GAMING DISPLAYS AND GAMING TERMINALS WITH A FLEXIBLE DISPLAY DEVICE

(71) Applicant: WMS Gaming Inc., Waukegan, IL (US)

(72) Inventor: Christopher W. Chudek, Evanston, IL (US)

(73) Assignee: WMS Gaming Inc., Waukegan, IL (US)

(21) Appl. No.: 14/295,397

(22) Filed: Jun. 4, 2014

Related U.S. Application Data
(60) Provisional application No. 61/830,926, filed on Jun. 4, 2013.

(51) Int. Cl. G07F 17/32

(52) U.S. Cl. CPC G07F 17/3211
USPC 463/31

(57) ABSTRACT

Gaming devices, gaming systems, methods of conducting wagering games, and reconfigurable gaming display assemblies are disclosed. A gaming machine for conducting a wagering game is presented. The gaming machine includes an input device for receiving an indication of a wager to play the wagering game. The gaming machine also includes a cabinet and a display device with a flexible video-display screen. The flexible video-display screen is operable to display aspects of the wagering game. A rigid support assembly is attached to the flexible video-display screen. The rigid support assembly includes one or more support brackets which movably mount the flexible video-display screen to the cabinet. The one or more support brackets are configured to transition towards the rear of the cabinet and thereby physically change the flexible video-display screen from a generally flat configuration to a generally curved configuration.

### CLAIM OF PRIORITY AND CROSS-REFERENCE TO RELATED APPLICATION

This application claims the benefit of priority to U.S. Provisional Patent Application No. 61/830,926, which was filed on Jun. 4, 2013, and is incorporated herein by reference in its entirety and for all purposes.

### COPYRIGHT

A portion of the disclosure of this patent document contains materials which are subject to copyright protection. The copyright owner has no objection to the facsimile reproduction by anyone of the patent disclosure as it appears in the U.S. Patent and Trademark Office patent files or records, but otherwise reserves all copyright rights whatsoever.

### TECHNICAL FIELD

The present disclosure relates generally to wagering games, as well as wagering game devices and gaming systems. More particularly, aspects of the present disclosure relate to reconfigurable gaming displays and gaming terminals with reconfigurable display devices.

### BACKGROUND

Gaming terminals, such as slot machines, video poker machines and the like, have become a cornerstone of the gaming industry. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Thus, gaming manufacturers continuously endeavor to develop new games and improved gaming enhancements that will attract frequent play and player loyalty through enhanced entertainment value to the player.

One concept that has been successfully employed to enhance the entertainment value of a game is the concept of a “secondary” or “bonus” game that may be played in conjunction with a “primary” or “basic” game. The bonus game may comprise any type of game, either similar to or completely different from the basic game, which is entered upon the occurrence of a selected event or outcome during play of the basic game. Generally, bonus games provide a greater expectation of winning than the basic game and may also be accompanied with more attractive or unusual video and/or audio features.

Another concept that has been employed is the use of progressive jackpots. In the gaming industry, a “progressive jackpot” involves collecting coin-in data from participating gaming device(s), such as slot machines, contributing a percentage of that coin-in data to a jackpot amount, and awarding that jackpot amount to a player upon the occurrence of a jackpot-winning event. A jackpot-winning event typically occurs when a “progressive winning position” is achieved at a participating gaming device. If the gaming device is a slot machine, a progressive winning position may, for example, correspond to alignment of progressive jackpot reel symbols along an active payline. The initial progressive jackpot is a predetermined minimum amount. That jackpot amount, however, progressively increases as players continue to play the gaming machine without winning the jackpot.

There are three main types of wagering game machines: mechanical, electromechanical, and electronic. The original slot machine, for example, was entirely mechanical in construction, working on an elaborate configuration of springs, gears, shafts, brakes and levers. Since its introduction in the early 1960's, the electromechanical gaming machine began replacing most, if not all, mechanical slot machines. Electromechanical gaming machines typically use one or more microprocessors to determine a random outcome, and electrical stepper motors to spin and stop a set of mechanical reels to display the game outcome. The electronic gaming machine (EGM), in comparison, subsequently supplanted the mechanical reels of the electromechanical gaming machine with simulated mechanical reels generated by a video-display device. In addition to slot-type wagering games, traditional table games, such as poker, blackjack, keno, and bingo, were adapted for use on EGMs.

The advent of microprocessors has significantly advanced the state of the art of electronic gaming. For instance, microprocessors offer gaming machines much greater latitude in determining random game outcomes. Random game outcomes are typically determined by a random number generator (RNG) that is driven by a central processing unit (CPU). A probability table contains all possible game outcomes, with each game outcome being assigned a distinct number. Once generated, the random number is used to look up the corresponding game outcome in the probability table. In electro-mechanical configurations, the CPU then signals the stepper motors to drive and position the reels to coincide with the randomly determined game outcome. As the complexity and capacity of microcomputer programs continue to grow, the graphics and audio of wagering games have also become more realistic and intense. As a result, different accessories have been provided to enhance the game playing experience. Surround-sound speaker systems and high-definition wide-screen displays are just some of the accessories that are available on modern gaming machines to enhance the graphic and acoustic output of wagering games and, thus, increase player enjoyment.

Many gaming machines include a variety of visual attractions and displays, such as models, signs, high-definition video displays, and other forms of graphical entertainment and information. These items typically include fixed permanently-printed glass, flat-panel video displays, artwork, models, and/or marquees. In many gaming regions, industry regulations in fact require each gaming terminal to include top-box mounted lighting and signage that indicate, for example, the class of machine, when the machine is of out of funds, when the machine is malfunctioning, etc.

Historically, each gaming machine was limited to a single game with a primary game display and an optional top-box mounted sign, flat-screen display panel or marquee assembly. In most configurations, the gaming terminal's various display devices are rigidly mounted to the cabinet in a fixed location, limited to providing a single view in a single orientation. Moreover, traditional electronic graphical display devices, such as cathode ray tube (CRT) displays, liquid crystal display (LCD) panels, plasma display panels, and light emitting diode (LED) displays, are rigid and inflexible, having a fixed size and shape, and therefore cannot expand, contract, or change form. There may therefore be a need for reconfigurable gaming display devices that are not limited to a single view, a single orientation, and/or a single shape.

### SUMMARY

Disclosed herein are flexible video-display devices, such as a flexible organic light emitting diode (OLED) display, for the primary or secondary display of an electromechanical gaming machine or electronic gaming machine (EGM). In accord with some of the disclosed embodiments, the display device includes a rigid support structure with linear mounting brackets placed at the top and bottom of a flexible OLED display screen. This support structure provides the flexible OLED display screen with functional and operational attachment points to the gaming machine cabinet. The support structure allows flexibility—e.g., the selective curving and straightening—of the flexible OLED screen about a horizontal axis. Alternative configurations provide flexibility around vertical and diagonal axes. Beginning with the display screen in a “flat” (standard video) configuration, one or both of the mechanical linear attachment points can then be repositioned to thereby “bend” the display screen, for example, to give the appearance of mechanical reels on the display screen.

According aspects of the present disclosure, a gaming machine for conducting a wagering game is disclosed. The gaming machine includes a cabinet, an input device, a display device and a rigid support assembly. The input device is configured to receive an indication of a wager to play the wagering game. The display device includes a flexible video-display screen, which is operable to display aspects of the wagering game. The rigid support assembly is attached to the flexible video-display screen. The rigid support assembly includes one or more support brackets that movably mount the flexible video-display screen to the cabinet. The one or more support brackets are configured to transition towards the rear of the cabinet and thereby physically change the flexible video-display screen from a generally flat configuration to a generally curved configuration.

According to other aspects of the present disclosure, a gaming system for conducting a wagering game is presented. The gaming system includes at least one input device, at least one processor, at least one memory, at least one cabinet, and at least one display assembly. Each display assembly includes a flexible video-display screen that is attached to a rigid support assembly. The flexible video-display screen is operable to display aspects of the wagering game. The rigid support assembly includes one or more support brackets that movably mount the flexible video-display screen to the cabinet. The one or more support brackets are configured to transition towards the rear of the cabinet and thereby physically change the flexible video-display screen from a generally flat configuration to a generally curved configuration.

In accordance with yet other aspects of the present disclosure, a free-standing gaming terminal is featured. The free-standing gaming terminal includes a cabinet, an input device, and a display assembly. The input device is operable for receiving wagers from players to play a wagering game, which includes a base game and a bonus game. The display assembly includes a flexible organic light emitting diode (OLED) display screen that is operable to display randomly determined outcomes of the wagering game. A rigid support assembly with first and second rigid support brackets movably mounts the flexible OLED display screen to the cabinet. The first and second support brackets are configured to move towards the rear of the cabinet and towards one another to thereby change the flexible OLED display screen from a substantially flat configuration to a curved configuration. The flexible OLED display is operable, in response to a bonus-game-triggering event in a randomly determined outcome of the base game, to automatically change to the curved configuration and display thereon a plurality of symbol-bearing bonus-game reels.

Aspects of the present disclosure are also directed to a method of operating a gaming machine for conducting a wagering game. The gaming machine includes a cabinet and an input device. The method includes: receiving, via the input device, an indication of a wager to play the wagering game; displaying, via a flexible video-display screen of the gaming machine, a randomly determined outcome of the wagering game, the flexible video-display screen being movably mounted to the cabinet of the gaming machine via first and second movable support brackets, the first movable support bracket being attached at a first end of the flexible video-display screen, and the second movable bracket being attached at a second end of the flexible video-display screen on the opposite side of the first end; and, in response to a predetermined event in the randomly determined outcome of wagering game, repositioning the first and second movable support brackets such that the flexible video-display screen changes from a generally flat configuration to a generally curved configuration.

In accordance with additional aspects of this disclosure, one or more physical non-transitory machine-readable storage media are featured that include instructions which, when executed by one or more processors, cause the one or more processors to direct a gaming terminal and/or a gaming system to perform operations disclosed herein.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an example of a free-standing gaming terminal according to aspects of the present disclosure.

FIG. 2 is a schematic diagram of an example of a gaming machine in a representative gaming system according to aspects of the present disclosure.

FIG. 3 is a screen shot of a representative basic-game screen of a wagering game displayed on a gaming terminal, gaming device, and/or gaming system according to aspects of the present disclosure.

FIG. 4A is a perspective-view illustration of a representative gaming terminal with a flexible primary display device in accordance with aspects of the present disclosure.

FIG. 4B is a partially cut-away side-view illustration of the gaming terminal of FIG. 4A, showing the flexible primary display device in a “flat” configuration.

FIG. 5A is another perspective-view illustration of the gaming terminal of FIGS. 4A and 4B, showing the flexible primary display device in a “curved” configuration.

FIG. 5B is a partially cut-away side-view illustration of the gaming terminal of FIG. 4A, also showing the flexible primary display device in a “curved” configuration.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games. It should also be noted that the recitation of a gaming terminal, machine, device or system may be used interchangeably in the specification and claims, unless explicitly delimited.

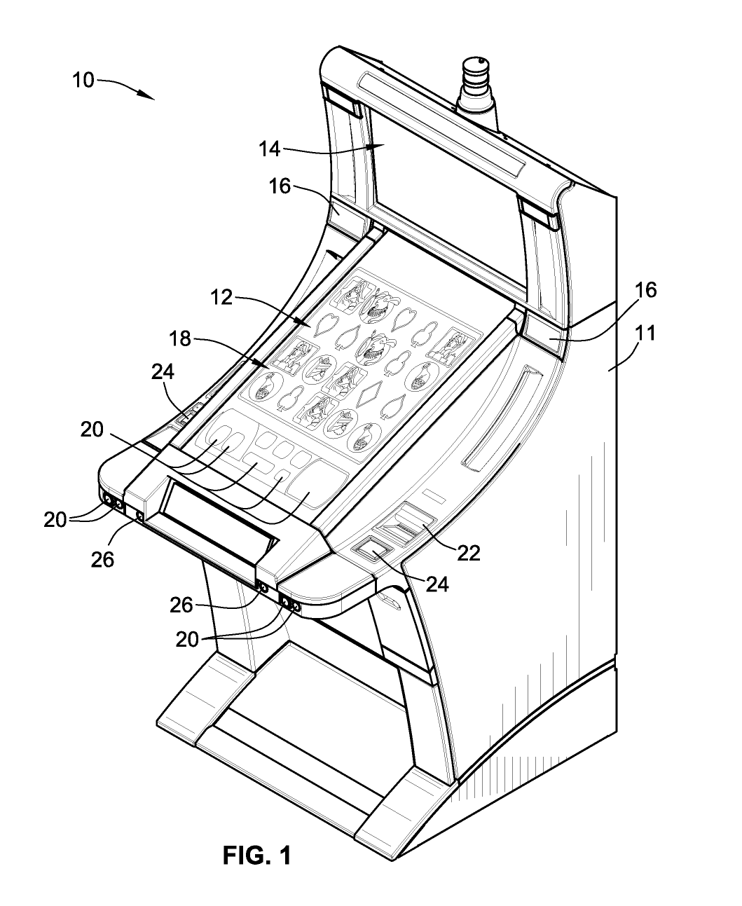

Referring to the drawings, wherein like reference numerals refer to like features throughout the several views, there is shown in FIG. 1 a representative gaming terminal 10 similar to those used in gaming establishments, such as casinos, hotels and cruise ships, and non-conventional gaming establishments, such as airports and restaurants. With regard to the present disclosure, the gaming terminal 10 may be any type of gaming terminal and may have varying structures and methods of operation. For example, in some aspects, the gaming terminal 10 is an electromechanical gaming terminal configured to play slots with mechanical reels, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models (as shown), handheld mobile devices, bartop models, workstation-type console models, etc. Further, the gaming terminal 10 may be primarily dedicated for use in conducting wagering games, or may include non-dedicated devices, such as mobile smartphones, personal digital assistants, personal computers, etc. Exemplary types of gaming terminals are disclosed in U.S. Pat. No. 6,517,433 B2, U.S. Patent Application Pub. Nos. US 2010/0069160 A1 and US 2010/0234099 A1, and International Application No. PCT/US2007/000792, all of which are incorporated herein by reference in their respective entireties and for all purposes.

The gaming terminal 10 illustrated in FIG. 1 comprises a cabinet 11 that may house various input devices, output devices, and input/output devices. By way of non-limiting example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display may be disposed in front of the mechanical-reel display to portray a video image superimposed upon the mechanical-reel display. A video display is, in various embodiments, a cathode ray tube (CRT), a high-resolution liquid crystal display (LCD), a plasma display, a light emitting diode (LED), a DLP projection display, an electroluminescent (EL) panel, or any other type of display suitable for use in the gaming terminal 10. The display areas may variously display information associated with wagering games, non-wagering games, community games, progressive games, advertisements, services, premium entertainment, text messaging, emails, alerts, announcements, broadcast information, subscription information, etc., appropriate to the particular mode(s) of operation of the gaming terminal 10. The gaming terminal 10 includes a touch screen(s) 18 mounted over the primary and/or secondary areas 12, 14, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present disclosure.

Video images in the primary display area 14 and/or the secondary display area 16 can be rendered in two-dimensional (e.g., using Flash Macromedia™) or three-dimensional graphics (e.g., using Renderware™). In various aspects, the video images are played back (e.g., from a recording stored on the gaming terminal 10), streamed (e.g., from a gaming network), or received as a TV signal (e.g., either broadcast or via cable). Such images can take different forms, such as animated images, computer-generated images, or “real-life” images, either prerecorded (e.g., in the case of marketing/promotional material) or as live footage. The format of the video images can include any format including, but not limited to, an analog format, a standard digital format, or a high-definition (HD) digital format.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals can be selected from a group consisting essentially of an electrical current, an electrical voltage, an electrical charge, an optical signal, an optical element, a magnetic signal, and a magnetic element.

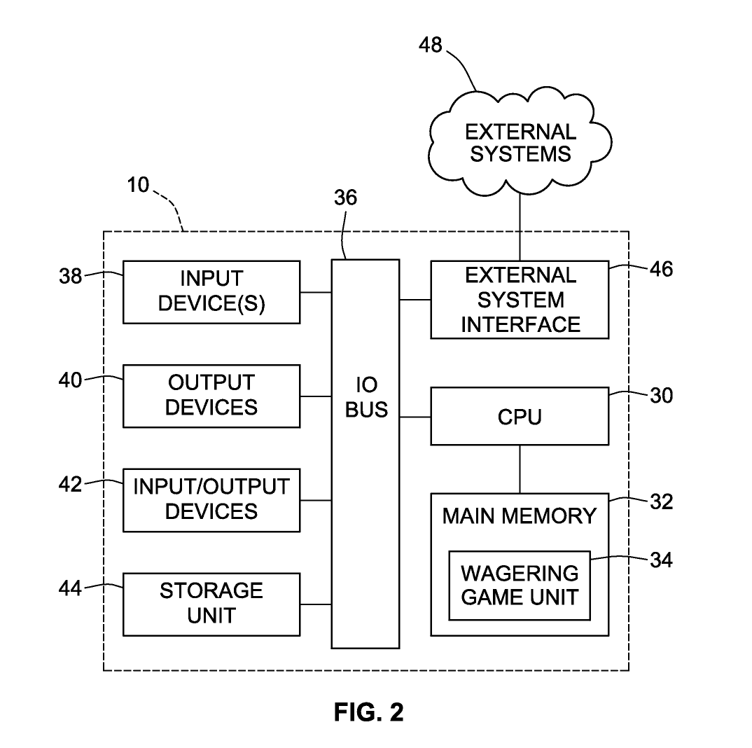

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by INTEL® and AMD®. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes a random number generator (RNG) for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

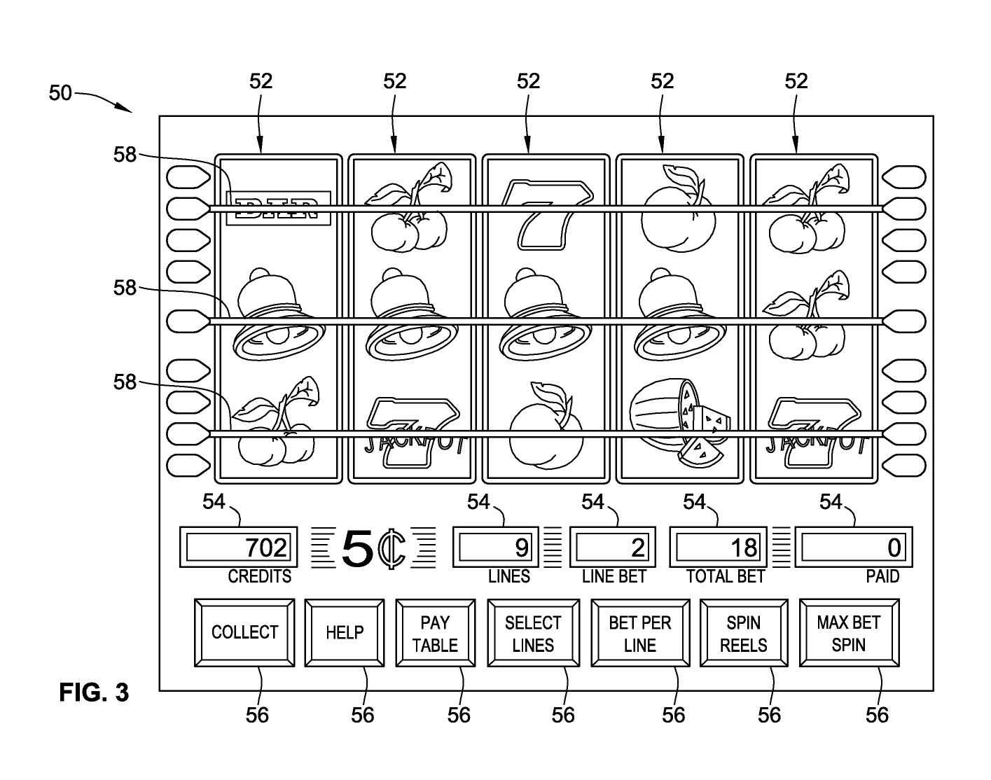

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by an RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

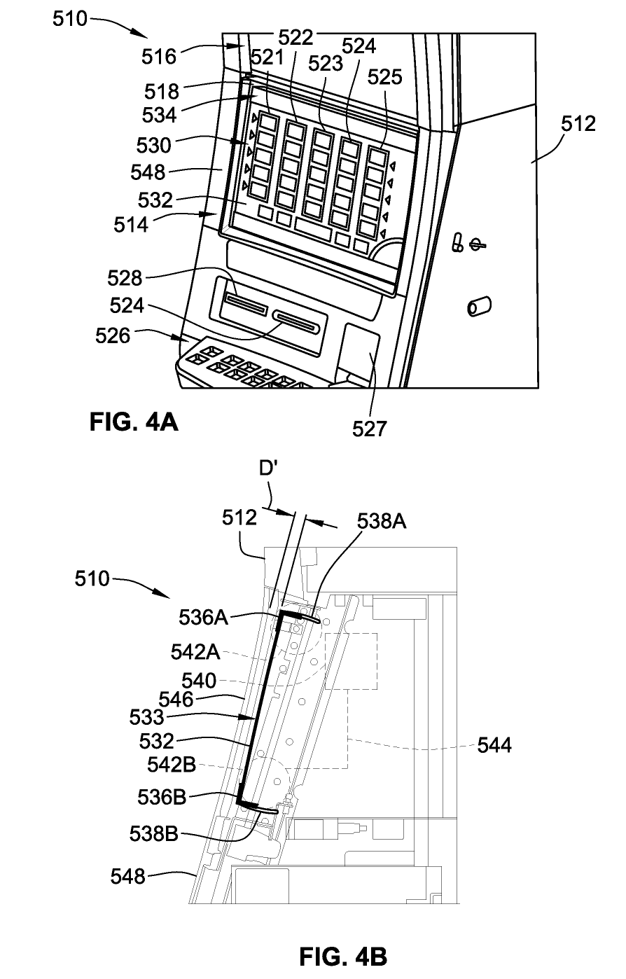

FIGS. 4A and 4B illustrate a representative gaming terminal, designated generally at 510, for playing one or more wagering games. Although differing in appearance, the gaming terminal 510 can be similar in function, operation and connectivity to the gaming terminal 10 discussed above with respect to FIGS. 1 and 2 and, thus, can include any of the options, features and alternatives described above. For example, the gaming terminal 510 (also referred to herein as “wagering game machine” or “gaming machine”) may be an electromechanical gaming terminal configured, for example, to play mechanical slots, or it may be an electronic gaming terminal configured, for example, to play a video casino game, such as keno, poker, slots, blackjack, roulette, etc. Markedly, the gaming terminal 510 is purely representative in nature, and presented solely for explanatory purposes.

The illustrated gaming terminal 510, which is shown as an upright free-standing gaming terminal, comprises a cabinet 512 for housing and/or supporting a variety of operational componentry (e.g., CPU 30, memory 32, external systems interface 46, etc.). For output devices, the gaming terminal 510 includes, among other things, a primary display area (or “first display device”) 514, and a secondary display area (or “second display device”) 516. Optional configurations can include more or fewer display devices than the two shown in FIG. 4. For input devices, the gaming terminal 510 may include a touchscreen 518, a bill receiving and validating device 527, an information reader/writer(s) 524, a button panel 526, and a ticket reader/printer 528, as some non-limiting examples. The gaming terminal 510 may include one or more other/alternative player input and output devices, including audio speakers, marquees, and/or one or more player-accessible ports (e.g., an audio output jack for headphones, a video headset jack, an internet cable jack, a wireless transmitter/receiver, etc.). In the illustrated example, the button panel 526 includes: (1) a set of mechanical wager-selection pushbuttons that allow a player to specify a wager amount for each selected payline; and, (2) a set of mechanical payline-selection pushbuttons that allow a player to select any of a number of possible payline configurations prior to spinning the reels. While these typical components found in the gaming terminal 510 are described above, it should be understood that numerous additional/alternative peripheral devices and other elements may exist and may be used in any number of combinations to create various forms of a gaming terminal.

The display device 514 displays or otherwise visually depicts a wagering game 530, which in this example is the slot game shown in FIG. 4A. The slot game 530 includes a plurality of symbol-bearing reels, designated as 521-525 in FIG. 4A, each having a plurality of distinct reel positions occupied by a number of symbols. These reels 521-525 displayed on the primary display 514 are computer-generated simulations of mechanical slot reels. The symbols borne by these reels may include any variety of graphical symbols, emblems, elements, or representations, including symbols that are associated with one or more themes of the gaming terminal 510. The symbols may also include a blank symbol or empty space. The symbols on the reels 521-525, when part of a wagering-game outcome, are arranged in an array, which in this embodiment is a 4×5 matrix—four rows by five columns—of distinct array positions. The reels 521-525 are varied (e.g., spun and stopped) to reveal combinations of symbols, which represent randomly selected outcomes of the wagering game 530, that are evaluated for winning combinations. Winning combinations of symbols landing, for example, on activated paylines (e.g., those paylines for which a wager has been received) which extend through the array positions, cause awards to be paid in accordance with one or more pay tables associated with the gaming terminal 510. In some embodiments, winning combinations of symbols include three or more like symbols aligned adjacent one another on an active pay line (e.g., left-to-right configuration, right-to-left configuration, or both). In some embodiments, symbol combinations are evaluated in accord with various other schemes such as, but not limited to, scatter pays.

Within the scope of this disclosure, the wagering game 530 can include greater or fewer than five symbol-bearing reels (simulated, mechanical, or otherwise), each of which may include greater or fewer reel positions than those shown in FIG. 4A. In alternate embodiments, the randomly selected outcomes may comprise greater or fewer than 20 symbols, and may take on a variety of different forms having greater or fewer rows and/or columns. The matrix may even comprise other non-rectangular forms or arrangements of symbols. Moreover, the randomly selected outcomes of the wagering game 530 may be varied from the representation provided in FIG. 4A. In addition, the display devices 514, 516 can be configured, individually or cooperatively, to display randomly determined bonus-game outcomes of the wagering game 530.

A local controller (e.g., CPU 30 of FIG. 2), a host system (e.g., external system 48 of FIG. 2), a central controller, or any combination thereof, in alternative embodiments, operates to execute a wagering game program causing one or more of the display areas 514, 516 to display selected portions of the wagering game 530. An outcome of the wagering game 530, be it for a base portion, a bonus portion, a progressive portion, a community portion, or otherwise, can be randomly selected from a predetermined set of potential (base, bonus, progressive, community, etc.) wagering-game outcomes, for example, using a local or remote random number generator (RNG). The wagering-game outcome is then revealed, displayed, or otherwise communicated to the player, for example, on a corresponding display device 514, 516. The game screen 514 of FIG. 4A, for example, displays the wagering-game outcome by portraying the reels 521-525 spinning and sequentially stopping to reveal reel symbols arranged in a symbol array. A winning combination occurs, for example, when the displayed array of symbols comprise one or more of the winning symbol combinations listed in a predetermined pay table. In response to a winning outcome, a wagering-game prize (e.g., a monetary award of credits) associated with that winning outcome is conferred upon the player.

One or more of the display areas 514, 516 may be configured as a “flexible” display device. By way of non-limiting example, the primary display device 514 of FIGS. 4A and 4B includes a flexible electronic video-display screen 532 operatively mounted to the cabinet 512 via a rigid support assembly 534. The flexible video-display screen 532 is bendable and elastic, and is operable to dynamically display information related to the wagering game. As used herein, the term “flexible video-display screen” should be defined or interpreted as inclusive of, but not exclusive to, display devices that create visual images, both moving and stationary alike, through the electronic generation and manipulation of light. By way of non-limiting example, the display screen 532 may be a flexible organic light emitting diode (OLED) display panel. One such flexible OLED display panel is the Active-Matrix Organic Light-Emitting Diode (AMOLED) screen, some of which are manufactured by LG Display Co., Ltd., of Seoul, South Korea. In another optional configuration, the flexible video-display screen 532 may include an organic thin-film transistor (OTFT) display panel, which may be integrated with OLED technology. One such OTFT display is the Rollable OTFT-Driven OLED Panel, which is manufactured by Sony Corp., of Tokyo, Japan. As used herein, the term “flexible video-display screen” should not be defined or interpreted as consisting of a projector screen or an electro-mechanically automated exhibit, such as moving marquees and mechanized cabinet ornaments.

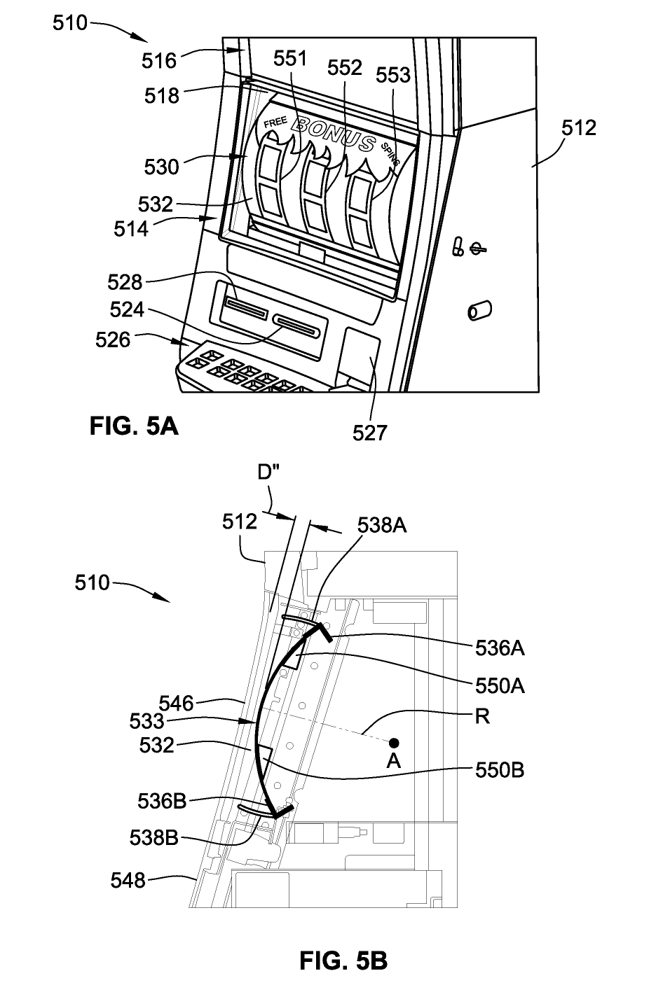

The rigid support assembly 534 includes one or more rigid support brackets that movably mount the flexible video-display screen 532 to the inside of the cabinet 512 of the gaming terminal 510. In the embodiment illustrated in FIGS. 4A and 4B, for example, the rigid support assembly 534 includes a first movable bracket 536A that is attached, e.g., via threaded fasteners or other coupling means, proximal a top (first) end of the flexible video-display screen 532. A second movable bracket 536B, which may be structurally identical to the first movable bracket 536A, is attached, e.g., via threaded fasteners or other coupling means, proximal a bottom (second) end of the flexible video-display screen 532. The first and second movable brackets 536A, 536B are each shown as a metallic, L-shaped crossbar; however, these support brackets 536A, 536B may comprise other sizes, shapes and materials within the scope of this disclosure. The movable support brackets 536A, 536B both extend substantially the entire width of the flexible video-display screen 532. The rigid support assembly 534 is designed to provide the structural integrity necessary to retain the flexible video-display screen 532 in the flat configuration (FIG. 4B), the curved configuration (FIG. 5B), and any configuration therebetween.

The flexible video-display screen 532 is designed to physically change shape during operation of the gaming terminal 510. The flexible video-display screen 532 can be changed, for example, from a generally flat shape, as shown in FIG. 4A, to a generally arcuate shape, as shown in FIG. 5A, and back. In an exemplary configuration where the display screen 526 is an OLED panel, the emissive electroluminescent layer, which is a film of organic compounds that emit light in response to an electric current, can be fabricated on a flexible plastic or metallic substrate. In so doing, the flexible OLED panel can be curved, bent, and/or folded without significantly distorting or skewing the displayed image. For at least some of the disclosed configurations, it is desirable that the display screen 532 be elastic such that the screen is capable of recovering its original shape after deformation.

In the illustrated embodiments, the movable support brackets 536A, 536B are configured to transition towards the rear of the cabinet 512 to thereby physically change the flexible video-display screen 532 from the flat configuration of FIGS. 4A and 4B to the curved configuration of FIGS. 5A and 5B. In accord with some of the disclosed concepts, each bracket 536A, 536B is aligned with and travels along a respective curved track (or “arcuate path”) 538A, 538B. A driving mechanism, such as the brushless DC electric stepper motor shown hidden at 540, is operatively coupled, e.g., via a timing-belt-drive system 544, to a pulley arrangement, represented herein by a pair of pulleys shown hidden at 542A and 542B. Each of the illustrated pulleys 542A, 542B is mechanically coupled, e.g., via a connector flange or track pin, to a respective one of the movable support brackets 536A, 536B. Through operation of the stepper motor 540, in conjunction with the timing-belt-drive system 544 and pulley arrangement 542A, 542B, the gaming terminal 510 can automate changing of the flexible video-display screen 532 between the generally flat and generally curved configurations. Alternative configurations can employ other driving means, such as AC electric motors, permanent magnet motors, and smart materials, and other forms of mechanical transmission, such as a chain-drive system or a belt-drive system. Some optional embodiments allow the shape of the flexible video-display screen 532 to be changed manually.

As the first and second movable brackets 536A, 536B transition along their arcuate paths 538A, 538B, the brackets 536A, 536B can shift from a forward-most position (e.g., FIG. 4B), proximate a front glass panel 546 attached to a front door 548 of the cabinet 512, towards the rear of the cabinet 512 and towards one another, to a rear-most position (e.g., FIG. 5B), distal from the front glass panel 546. In so doing, the upper and lower ends of the flexible video-display screen 532 also move in the direction of the back of the cabinet 512 and towards one another, which causes the flexible video-display screen 532 to curve around a horizontal axis A and bow into the curved configuration seen in FIG. 5B. The gaming terminal 10 may include one or more optional contoured die 550A and 550B, each of which includes a curved forward-facing surface against which the back of the display screen 532 presses when in the curved configuration. The flexible video-display screen 532 can subsequently be returned to a generally or substantially flat configuration by returning the movable brackets 536A, 536B to their respective forward-most positions (e.g., FIG. 4B) proximate the front glass panel 546. Alternative configurations can provide selective bowing around a vertical or diagonal axis. In this regard, additional or alternative shapes are also envisioned, including spherical and semi-spherical shapes, conical and frusta-conical shapes, sinusoidal and other wave-shaped patterns, etc.

As indicated above, the flexible video-display screen 532 is mounted via the rigid support assembly 534 inside the cabinet 512 behind the front glass panel 546. A central region 533 of the flexible video-display screen 532 is a predetermined distance (e.g., distance D′ in FIG. 4B) from the front glass panel 546 when the display screen 532 is in the generally flat configuration of FIGS. 4A and 4B. For some of the disclosed configurations, the distance between the central region 533 of the flexible video-display screen 532 and the front glass panel 546 when in the flat configuration, designated as distance D′ in FIG. 4B, and when in the curved configuration, designated as distance D″ in FIG. 5B, is substantially the same. That is, this distance is maintained as the flexible video-display screen 532 transitions back and forth between flat and curved states to ensure that the screen 532 does not inadvertently press against and get damaged by the front glass panel 546 when changing shape.

In some configurations, the flexible video-display screen 532 is operable to automatically change shape in response to events in the wagering game, other game-related and non-game-related events, user-input preferences, operator-input preferences, or any combination thereof. By way of non-limiting example, the driving mechanism 540 can be operated (e.g., via CPU 30) to selectively reconfigure the display screen 532, or selected portions thereof, in response to random events occurring in or during the wagering game 530. In one instance, the wagering game 530 includes a base game portion, which is depicted in FIG. 4A, and a bonus game portion, which is depicted in FIG. 5A. Upon the occurrence of a bonus-game-triggering event, such as three free-spin-bonus symbols appearing adjacent one another on an active payline in a randomly determined outcome of the base game, an internally or remotely located CPU can direct the driving mechanism 540 to reposition the first and second movable brackets 536A, 536B such that the flexible video-display screen 532 changes to the curved configuration. After the display screen 532 takes on a curved shape, the display screen 532 is shown in FIG. 5A displaying a plurality of FREE SPIN BONUS symbol-bearing bonus-game reels 551-553.

One potentially desirable intent of bending the flexible video-display screen 532 is so the base-game and/or bonus-game symbol-bearing reels displayed thereon appear to players to more closely resemble mechanical reels. In this regard, the radius of curvature R of the flexible video-display screen 532, when in the curved state of FIG. 5B, can be approximately equal to a radius of curvature of a conventional mechanical reel used within a mechanical-reel style of slot gaming machine (e.g., approximately four to seven inches). Since the images produced by the flexible video-display screen 532 are dynamic images that move in a manner that is similar to the movement of symbols on a mechanical slot reel, from a player's perspective, these images appear to be actual symbols rotating on an actual mechanical slot reel.

Also disclosed herein are methods of operating a gaming machine for conducting a wagering game. In one embodiment, the method includes receiving, via an input device of the gaming machine, an indication of a wager to play a wagering game, such as the various wagering games disclosed hereinabove. The method also includes displaying, via a flexible video-display screen of the gaming machine, a randomly determined outcome of the wagering game. This step may include an arrangement of symbol-bearing slot reels that are varied (e.g., spun and stopped) to reveal combinations of symbols, which represent randomly selected outcomes of the wagering game, that are evaluated for winning combinations.

As described above, the flexible video-display screen is movably mounted to the cabinet of the gaming machine via one or more rigid but movable support brackets. A first movable support bracket can be attached at a first end of the flexible video-display screen, while a second movable bracket can be attached at a second end of the flexible video-display screen on the opposite side of the first end. The method may then include, in response to a predetermined event in the randomly determined outcome of wagering game, repositioning the movable support brackets such that the flexible video-display screen changes from a generally flat configuration to a generally curved configuration.

In some embodiments, the method includes at least those steps enumerated above. It is also within the scope and spirit of the present invention to omit steps, include additional steps, and/or modify the order presented above. It should be further noted that the foregoing method can be representative of a single sequence for playing a wagering game. However, it is expected that the method will be practiced in a systematic and repetitive manner.

While many embodiments and modes for carrying out the present invention have been described in detail above, those familiar with the art to which this invention relates will recognize various alternative designs and embodiments for practicing the invention within the scope of the appended claims.

What is claimed is:

1. A gaming machine for conducting a wagering game, the gaming machine comprising:
an input device configured to receive an indication of a wager to play the wagering game;
a cabinet;
a display device including a flexible video-display screen, the flexible video-display screen being operable to display aspects of the wagering game; and
a rigid support assembly attached to the flexible video-display screen, the rigid support assembly including one or more support brackets movably mounting the flexible video-display screen to the cabinet, the one or more support brackets being configured to transition towards the rear of the cabinet and thereby physically change the flexible video-display screen from a generally flat configuration to a generally curved configuration.

2. The gaming machine of claim 1, wherein the one or more support brackets includes a first movable bracket attached at a first end of the flexible video-display screen and a second movable bracket attached at a second end of the flexible video-display screen on the opposite side of the first end.

3. The gaming machine of claim 2, wherein the first and second movable brackets transition towards the rear of the cabinet and towards one another to thereby change the flexible video-display screen from the generally flat configuration to the generally curved configuration.

4. The gaming machine of claim 2, wherein the first and second movable brackets each transitions along a respective arcuate path towards the rear of the cabinet to thereby change the flexible video-display screen from the generally flat configuration to the generally curved configuration.

5. The gaming machine of claim 2, wherein the first and second movable brackets extend substantially the entire width of the flexible video-display screen.

6. The gaming machine of claim 1, further comprising a front glass panel attached to the front of the cabinet, the flexible video-display screen being mounted via the rigid support assembly inside the cabinet behind the front glass panel.

7. The gaming machine of claim 5, wherein a central region of the flexible video-display screen is a predetermined distance from the front glass panel, the predetermined distance between the central region and the front glass panel being substantially the same after the flexible video-display screen transitions from the flat configuration to the curved configuration.

8. The gaming machine of claim 1, further comprising a contoured die with a curved surface against which the flexible video-display screen presses when in the curved configuration.

9. The gaming machine of claim 1, further comprising a driving mechanism configured to automate changing the display screen between the generally flat configuration and the generally curved configuration.

10. The gaming machine of claim 1, wherein the flexible video-display screen curves around a horizontal axis or a vertical axis when changing from the flat configuration to the curved configuration.

11. The gaming machine of claim 1, wherein a radius of curvature of the flexible video-display screen when in the curved configuration is approximately equal to a radius of curvature of a mechanical slot reel.

12. The gaming machine of claim 1, wherein the flexible video-display screen includes an organic light emitting diode (OLED) display panel.

13. The gaming machine of claim 1, wherein the flexible video-display screen is operable to automatically change to the generally curved configuration responsive to events in the wagering game, user-input preferences, or operator-input preferences, or any combination thereof.

14. The gaming machine of claim 1, wherein the wagering game includes a base game and a bonus game, and wherein the flexible video-display screen is operable, in response to a bonus-game-triggering event in a randomly determined outcome of the base game, to automatically change to the curved configuration and display thereon a plurality of symbol-bearing bonus-game reels.

15. A gaming system for conducting a wagering game, the gaming system comprising:
at least one input device;
at least one processor;
at least one memory;
at least one cabinet; and
at least one display assembly including a flexible video-display screen attached to a rigid support assembly, the flexible video-display screen being operable to display aspects of the wagering game, the rigid support assembly including one or more support brackets movably mounting the flexible video-display screen to the cabinet, the one or more support brackets being configured to transition towards the rear of the cabinet and thereby physically change the flexible video-display screen from a generally flat configuration to a generally curved configuration.

16. A method of operating a gaming machine for conducting a wagering game, the method comprising:
receiving, via an input device of the gaming machine, an indication of a wager to play the wagering game;
displaying, via a flexible video-display screen of the gaming machine, a randomly determined outcome of the wagering game, the flexible video-display screen being movably mounted to a cabinet of the gaming machine via first and second movable support brackets, the first movable support bracket being attached at a first end of the flexible video-display screen and the second movable bracket being attached at a second end of the flexible video-display screen on the opposite side of the first end; and
in response to a predetermined event in the randomly determined outcome of wagering game, repositioning the first and second movable support brackets such that the flexible video-display screen changes from a generally flat configuration to a generally curved configuration.

17. The method of claim 16, wherein the first and second movable support brackets each transitions along a respective arcuate path towards the rear of the cabinet to thereby change the flexible video-display screen from the flat configuration to the curved configuration.

18. The method of claim 16, wherein the first and second movable support brackets extend substantially the entire width of the flexible video-display screen.

19. The method of claim 16, wherein the flexible video-display screen is mounted inside the cabinet behind a front glass panel, and wherein a central region of the flexible video-display screen is a predetermined distance from the front glass panel, the predetermined distance between the central region and the front glass panel being substantially the same after the flexible video-display screen transitions from the flat configuration to the curved configuration.

20. The method of claim 16, wherein the wagering game includes a base game and a bonus game, and wherein the flexible video-display screen is operable, in response to a bonus-game-triggering event in a randomly determined outcome of the base game, to automatically change to the curved configuration and display thereon a plurality of symbol-bearing bonus-game reels.
